(19) United States
(12) Patent Application Publication
(10) Pub. No.: US 2007/0255016 A1
(43) Pub. Date: Nov. 1, 2007

(54) Spherical Resin Fine Particle, Method of Producing Spherical Resin Fine Particle, and Spacer for Liquid Crystal Display Device

(75) Inventor: Keizo Yamaguchi, Shiga (JP)

Correspondence Address: RADER FISHMAN & GRAUER PLLC, LION BUILDING, 1233 20TH STREET N.W., SUITE 501, WASHINGTON, DC, 20036, US

(73) Assignee: Sekisui Chemical Co., Ltd., Osaka-city, Osaka (JP)

(21) Appl. No.: 11/662,099

(22) PCT Filed: Sep. 27, 2005
(86) PCT No.: PCT/JP05/17704

§ 371 Date: Mar. 7, 2007

(30) Foreign Application Priority Data
Sep. 28, 2004 (JP) 2004-282806
Jan. 21, 2005 (JP) 2005-014666

(51) Int. Cl. C08F 2/04; C08G 85/00

(52) U.S. Cl. 526/63

(57) ABSTRACT

This invention provides spherical resin fine particles, which, even when produced by a seed polymerization method, have a smooth surface, a process for producing the spherical resin fine particles, and a spacer for a liquid crystal display element which uses the spherical resin fine particles, has a smooth surface, and is less likely to move after spreading onto a liquid crystal panel. The spherical resin fine particles are spherical resin fine particles produced by seed polymerization, and, in the observation of the surface of the spherical resin fine particles under an FE-SEM electron photomicrograph, when projections which appear on the surface in the plane of orthographic projection of the spherical resin fine particles is comparted as one region, the number of regions which appear in a concentric circle having a diameter of the half of the diameter of the spherical resin fine particles is not more than 10. The process for producing the spherical resin fine particles comprises dispersing a polymerizable unsaturated monomer and a polymerization initiator in water, absorbing the dispersion into seed particles having a weight average molecular weight of 2000 to 15000 and a weight average molecular weight/number average molecular weight of not more than 1.6 with a degree of swelling of 10 to 100 times, and polymerizing the polymerizable unsaturated monomer to prepare polymer fine particles.

### TECHNICAL FIELD

The present invention relates to a spherical resin fine particle, a method of producing a spherical resin fine particle, and a spacer for a liquid crystal display device, and particularly to a spherical resin fine particle having a smooth surface, formed by seed polymerization process, a method of producing the spherical resin fine particle, and a spacer for a liquid crystal display device using the spherical resin fine particle.

### BACKGROUND ART

A spherical resin fine particle used for a spacer for a liquid crystal display device requires having a uniform particle diameter thereof. Conventionally, as a method of obtaining a particle having a uniform particle diameter, a method in which a particle having a uniform particle diameter was formed by classifying particles obtained by suspension polymerization has been often employed. However, by such a method, a yield of a particle obtained was low and the uniformity of the particle diameter was unsatisfactory.

As another methods of producing a monodisperse particle having a uniform particle diameter, a seed polymerization method, in which a vinyl monomer is absorbed in a monodisperse particle such as styrenic polymers and then polymerized to increase the particle diameter of the monodisperse particle, is known. In this method, a spherical resin fine particle having a uniform particle diameter of around 1 to 10 μm, used as a spacer for a liquid crystal display device, can be generally obtained.

As such a seed polymerization process, a seed polymerization process of two-stage swelling is disclosed, for example, in Patent Document 1. In accordance with this process, a polymer having a uniform particle diameter can be obtained, but it is necessary that a hydrophobic organic compound referred to as a swelling aid is absorbed in a seed particle in advance to enhance a swelling power of the seed particle and then a vinyl monomer is absorbed in the seed particle to polymerize the vinyl monomer. In such a method, since two steps absorbing the swelling aid and the monomer, respectively are required, there was a problem that operations becomes complicated. Also, there was a problem that the swelling aid not involved in polymerization was eluted from the particle after polymerization.

However, it is known that a resin particle exhibits a high swelling power even though the swelling aid is not used when the seed particle having a low polymerization degree is used, and therefore if the seed particle having such a low polymerization degree is used, a spherical resin fine particle having a particle diameter of about 1 to 10 μm can be obtained at the first stage. For example in Patent Document 2, a method of producing a highly monodisperse particle by polymerizing by seed polymerization using a seed particle having a weight average molecular weight of 1000 to 20000 is disclosed.

On the other hand, the spherical resin fine particle used for a spacer for a liquid crystal display device requires that a spacer does not move after being sprayed onto a liquid crystal panel in addition to have a uniform particle diameter of the spherical resin fine particle.
Patent Document 1: Japanese Examined Patent Publication No.57-24369
Patent Document 2: Japanese Unexamined Patent Publication No.8-176214

### DISCLOSURE OF THE INVENTION

The above-mentioned movement of a spacer after being sprayed onto a liquid crystal panel tends to occur in the spherical resin fine particle obtained by a seed polymerization process compared with the spherical resin fine particle obtained by a suspension polymerization process, and it is thought that this results from the smoothness of the surface of the spherical resin fine particle.

As for a spherical resin fine particle obtained by seed polymerization process, since vinyl monomer is absorbed in a seed particle, the seed particle is swelled, and then the vinyl monomer is polymerized, the surface after polymerization has projections in scale form and the smoothness of the surface is impaired if the seed particle did not swell uniformly. When the seed particle having a low polymerization degree is used, this smoothness of the surface is enhanced by high swelling power. However, even if seed particles having a weight average molecular weight of 1000 to 20000 as shown in Patent Document 2 were used, the distribution range of molecular weight of the seed particles were wide and the adequate smoothness of the surface was not yet attained.

In view of the above state of the art, it is an object of the present invention to provide a spherical resin fine particle which has a smooth surface even though it is formed by seed polymerization process, a method of producing the spherical resin fine particle, and a spacer for a liquid crystal display device using the spherical resin fine particle, which has a smooth surface and hardly moves after being sprayed onto a liquid crystal panel.

In order to achieve the above-mentioned object, the invention according to claim 1 (the first present invention) provides a spherical resin fine particle obtained by seed polymerization, wherein when the surface of said spherical resin fine particle is observed with a FE-SEM type electron microscope and a projection section presented at the surface of the spherical resin is marked off in a plane of orthographic projection of the spherical resin fine particle, number of the marked off areas presented in a circle, which has a diameter of half of that of the spherical resin fine particle and is concentric with the spherical resin fine particle, is 10 or less.

Further, the invention according to claim 2 provides the spherical resin fine particle according to claim 1, wherein the above-mentioned spherical resin fine particle has a number average particle diameter of 1 to 10 μm.

Further, the invention according to claim 3 provides the spherical resin fine particle according to claim 1 or 2, wherein the above-mentioned spherical resin fine particle is a crosslinked resin including a polymer, consisting of a polymerizable unsaturated monomer containing polyfunctional (meth)acrylate in an amount 50 to 100% by weight, in an amount 90% by weight or more.

Further, the invention according to claim 4 (the second present invention) provides a method of producing the spherical resin fine particle according to claim 1 or 2, in which a polymerizable unsaturated monomer and a polymerization initiator are dispersed in water and then absorbed in the seed particle, which has a weight average molecular weight of 2000 to 15000 and in which (weight average molecular weight)/(number average molecular weight) is 1.6 or less, in a swelling degree of 10-fold to 100-fold and the absorbed polymerizable unsaturated monomer is polymerized to obtain a polymer particle.

Further, the invention according to claim 5 provides the method of producing a spherical resin fine particle according to claim 4, wherein the polymerizable unsaturated monomer contains polyfunctional (meth)acrylate in an amount 50 to 100% by weight

Further, the invention according to claim 6 (the third present invention) provides a spacer for a liquid crystal display device, wherein the above-mentioned spacer consists of a particle obtained using the spherical resin fine particle according to any one of claims 1 to 3 or a spherical resin fine particle produced by the method of producing a spherical resin fine particle according to claim 4 or 5.

### BRIEF DESCRIPTION OF THE DRAWINGS

FIG. 1 is a FE-SEM type electron microscope photograph of a spherical resin fine particle obtained in Example 1.

FIG. 2 is a FE-SEM type electron microscope photograph of a spherical resin fine particle obtained in Example 2.

FIG. 3 is a FE-SEM type electron microscope photograph of a spherical resin fine particle obtained in Comparative Example 2.

FIG. 4 is a schematic front view showing a state of marking off a projection section presented at the surface in observing the spherical resin fine particle with a FE-SEM type electron microscope photograph in the present invention.

### BEST MODE FOR CARRYING OUT THE INVENTION

Hereinafter, the present invention will be described in detail.

A spherical resin fine particle of the first present invention is obtained by seed polymerization.

The above-mentioned seed polymerization is generally a process in which the polymerizable unsaturated monomer and the polymerization initiator are dispersed in water and then absorbed in the seed particle and the polymerizable unsaturated monomer is polymerized to obtain a polymer particle. Therefore, the obtained spherical resin fine particle becomes a particle having an extremely narrow particle size distribution and a uniform particle diameter.

Further, the spherical resin fine particle of the first present invention requires that when the surface of the spherical resin fine particle is observed with a FE-SEM type electron microscope and each of projection sections presented at the surface of the spherical resin is marked off in a plane of orthographic projection of the spherical resin fine particle, number of the marked off areas presented in a circle, which has a diameter of half of that of the spherical resin fine particle and is concentric with the spherical resin fine particle, is 10 or less.

In the first present invention, the surface of the spherical resin fine particle is observed with a FE-SEM type electron microscope. Incidentally, this observation may be carried out on an electron microscope photograph. In this case, when there are projection sections presented at the surface, each of these projection sections was marked off and number of the marked off areas was counted. That is, as shown schematically in FIG. 4, each of a plurality of projection sections 11 presented in a concentric circle 12 is marked off as one area 13 in a plane of orthographic projection of the spherical resin fine particle 10. Marking off the projection section 11 means to define the area 13 surrounding the projection section 11 in order to distinguish the projection section 11 from a region outside the projection section 11. The number of this areas 13 is number of projection sections presented in a circle 12, which has a diameter of half of that of the spherical resin fine particle and is concentric with the spherical resin fine particle, in a plane of orthographic projection of the spherical resin fine particle. Therefore, the number of marked off areas presented in the above-mentioned concentric circle 12 is important. Specifically, it is necessary that number of areas 13 is 10 or less, the number of which is obtained by marking off each of projection sections presented in a circle 12 which has a diameter of half of that of the spherical resin fine particle and is concentric with the spherical resin fine particle.

If the above-mentioned number of areas marked off is more than 10, the smoothness of the surface of the spherical resin fine particle is not maintained and therefore the spherical resin fine particle may tends to move, for example, when it is sprayed onto a liquid crystal panel as a spacer for a liquid crystal display device.

The above-mentioned FE-SEM type electron microscope is a field emission scanning electron microscope and it can observe at high resolution compared with a general-purpose scanning electron microscope (SEM) since an electron beam can be narrowed.

As for a magnification of a microscope in the observation of the surface of the spherical resin fine particle, a magnification at which the spherical resin fine particle is easily observed may be selected, and for example, a magnification of 20000 times for at least 1 μm and less than 4 μm, 15000 times for at least 4 μm and less than 7 μm, 10000 times at least 7 μm and less than 10 μm, and 5000 times for at least 10 μm and less than 15 μm may be employed.

The spherical resin fine particle of the first present invention can be designed at will by changing a particle diameter of the seed particle to be used and a mixing ratio between the above-mentioned polymerizable unsaturated monomer and the seed particle, but when the spherical resin fine particle is used for a spacer for a liquid crystal display device, the spherical resin fine particle, which has a number average particle diameter of 1 to 10 μm and has a uniform particle diameter that the value of a coefficient of variance (CV value) (value determined by dividing a standard deviation in the particle size distribution by a number average particle diameter and expressing the divided value on a percentage basis) is 10% or less, is preferred, and the spherical resin fine particle having a number average particle diameter of 3.5 to 10 μm is more preferred.

Accordingly, the spherical resin fine particle of the first present invention preferably has a number average particle diameter of 1 to 10 μm. Further, it more preferably has a number average particle diameter of 3.5 to 10 μm.

As a method of producing the spherical resin fine particle of the first present invention, the so-called seed polymerization process of dispersing the polymerizable unsaturated monomer and the polymerization initiator in water and then allowing the seed particle to absorb the polymerizable unsaturated monomer and the polymerization initiator and polymerizing the polymerizable unsaturated monomer can be employed, but a method, in which the seed particle has a weight average molecular weight of 2000 to 15000 and (weight average molecular weight)/(number average molecular weight) is 1.6 or less and the polymerizable unsaturated monomer is absorbed in the seed particle in a swelling degree of 10-fold to 100-fold, is preferred so that the surface of the spherical resin fine particle is smooth.

Accordingly, a method of producing the spherical resin fine particle of the first present invention, in which the polymerizable unsaturated monomer and the polymerization initiator are dispersed in water and then absorbed in the seed particle, which has a weight average molecular weight of 2000 to 15000 and in which (weight average molecular weight)/(number average molecular weight) is 1.6 or less, in a swelling degree of 10-fold to 100-fold and the absorbed polymerizable unsaturated monomer is polymerized to obtain a polymer particle, also constitutes the present invention.

The spherical resin fine particle of the first present invention is preferably a crosslinked resin including a polymer, consisting of a polymerizable unsaturated monomer containing polyfunctional (meth)acrylate in an amount 50 to 100% by weight, in an amount 90% by weight or more. Herein, the polyfunctional (meth)acrylate refers to polyfunctional methacrylate or polyfunctional acrylate.

In the case where the spherical resin fine particle is a crosslinked resin including a polymer, consisting of a polymerizable unsaturated monomer containing polyfunctional (meth)acrylate in an amount 50 to 100% by weight, in an amount 90% by weight or more, since a polymerizable unsaturated monomer is polymerized using the polymerizable unsaturated monomer so as to contain polyfunctional (meth)acrylate among polyfunctional monomers described later in a large amount 50 to 100% by weight at the time of swelling and polymerizing, polyfunctional (meth)acrylate having higher hydrophilicity than divinylbenzene exists in a large amount at the surface of the particle compared with the case where divinylbenzene is used in a large amount and therefore it is conceivable that a glass transition point of the surface of the spherical resin fine particle become lower than the polymer particle obtained by polymerizing divinylbenzene in a large amount. Thus, in this case, since the surface of the spherical resin fine particle has a low glass transition point, the spherical resin fine particle becomes harder to move after being sprayed onto a liquid crystal panel when it is used as a spacer for a liquid crystal display device. Further, the spherical resin fine particle has adequate mechanical strength since it is a crosslinked resin.

In order to cause the spherical resin fine particle of the first present invention to be a crosslinked resin including a polymer, consisting of a polymerizable unsaturated monomer containing polyfunctional (meth)acrylate in an amount 50 to 100% by weight, in an amount 90% by weight or more, a polymerizable unsaturated monomer, in which the content of polyfunctional (meth)acrylate is 50 to 100% by weight, may be used, absorbed in a seed particle in a swelling degree of 10-fold to 100-fold, and polymerized.

In a method of producing a spherical resin fine particle of the second present invention, it is necessary that a polymer particle is obtained by dispersing the polymerizable unsaturated monomer and the polymerization initiator in water, and then absorbing the polymerizable unsaturated monomer and the polymerization initiator in the seed particle, which has a weight average molecular weight of 2000 to 15000 and in which (weight average molecular weight)/(number average molecular weight) is 1.6 or less, in a swelling degree of 10-fold to 100-fold, and polymerizing the polymerizable unsaturated monomer.

Hereinafter, the method of producing a spherical resin fine particle of the second present invention will be described in more detail.

It is necessary that a weight average molecular weight of the seed particle in the second present invention is 2000 to 15000. When the weight average molecular weight is less than 2000, the seed particle becomes apt to coalesce and a monodisperse particle having sphericity becomes hard to be formed, and when the weight average molecular weight is more than 15000, it becomes difficult to absorb a polymerizable unsaturated monomer to be added later, and swelling may not become uniform because of the reduction in swelling power and the surface of a spherical resin fine particle may not become smooth.

In addition, the molecular weight is a molecular weight on the polystyrene equivalent basis measured by gel permeation chromatography (GPC).

Further, it is necessary that (weight average molecular weight)/(number average molecular weight) of the seed particle is 1.6 or less. When the (weight average molecular weight)/(number average molecular weight) exceeds 1.6, it becomes difficult to uniformly absorb a polymerizable unsaturated monomer to be added later, and swelling may not become uniform and the surface of a spherical resin fine particle may not become smooth.

It is necessary that the swelling degree of the seed particle formed by absorbing the polymerizable unsaturated monomer and the polymerization initiator in a seed particle is 10-fold to 100-fold. When the swelling degree is less than 10-fold, the swelling is inadequate and therefore the surface of a spherical resin fine particle may not become smooth due to shrinkage by heat in polymerization, and when it is more than 100-fold, the seed particle cannot absorb the whole polymerizable unsaturated monomer to be added later and it cannot swell fully, and therefore the surface of a spherical resin fine particle may not become smooth.

In addition, the swelling degree referred to herein is defined by a volumetric ratio of a swelled particle to a not-yet-swelled seed particle. The completion of absorption is determined by identifying the expansion of a particle diameter by, for example, the observation by an optical microscope.

When the weight average molecular weight of the seed particle in the second present invention is 2000 to 15000 and (weight average molecular weight)/(number average molecular weight) of the seed particle is 1.6 or less, it is thought that it is possible to solubilize and absorb a polymerizable unsaturated monomer to be added later even when the swelling degree is high and the seed particle swells fully and therefore swells uniformly and therefore the surface of a spherical resin fine particle to be obtained becomes smooth without becoming rough even though being subjected to shrinkage by heat in polymerization.

The above-mentioned seed particle is not particularly limited as long as it absorbs the polymerizable unsaturated monomer and the polymerization initiator, but a polymer containing styrene and derivatives thereof in an amount 50% by weight or more is suitably used.

Examples of the above-mentioned styrene derivatives include p-methylstyrene, p-chlorostyrene, p-chloromethylstyrene, and p-methoxystyrene, and these derivatives may be used singly or in combination of two or more species.

As a component other than the above-mentioned styrene and derivatives thereof, (meth)acrylate esters and derivatives thereof, and butadiene are used. Herein, (meth)acrylate ester refers to methacrylate ester or acrylate ester.

As a method of polymerizing the above-mentioned seed particle, for example, soap-free polymerization or dispersion polymerization is used, but the method is not limited to these method and publicly known technologies are applicable.

As a polymerization initiator used in the above-mentioned polymerization of the seed particle, a polymerization initiator used in usual soap-free polymerization or dispersion polymerization can be used and it is not particularly limited and for example, potassium persulfate and azo initiators can be used.

In the above-mentioned polymerization of the seed particle, in order to obtain the seed particle which has a weight average molecular weight of 2000 to 15000 and in which (weight average molecular weight)/(number average molecular weight) is 1.6 or less, it is preferred to use a chain transfer agent. As the chain transfer agent, a chain transfer agent generally used in polymerization can be used and it is not particularly limited and for example, alkyl mercaptan-based chain transfer agents having 10 or less carbon atoms can be used.

As the above-mentioned seed particle, a non-crosslinked particle, which has a number average particle diameter of 0.1 to 10 μm and the value of a coefficient of variance (CV value) (value determined by dividing a standard deviation in the particle size distribution by a number average particle diameter and expressing the divided value on a percentage basis) of 10% or less, is preferred.

The above-mentioned polymerizable unsaturated monomer is not particularly limited and includes monofunctional monomers and polyfunctional monomers, and these monomers may be used singly or in combination of two or more species.

A proportion of the above polyfunctional monomer of the above polymerizable unsaturated monomer is preferably 15% by weight or more since the low proportion causes the mechanical strength of the polymer particle to decrease, and the proportion is more preferably 30% by weight or more. Further, a proportion of the polyfunctional monomer may be 100% by weight, that is, the whole polymerizable unsaturated monomer may be polyfunctional monomer.

The above-mentioned monofunctional monomer is not particularly limited and includes, for example, styrene derivatives such as styrene, α-methylstyrene, p-methylstyrene, p-chlorostyrene and chloromethylstyrene; vinyl esters such as vinyl chloride, vinyl acetate and vinyl propionate; unsaturated nitriles such as acrylonitrile; (meth)acrylate esters such as methyl (meth)acrylate, ethyl (meth)acrylate, butyl (meth)acrylate, 2-ethylhexyl (meth)acrylate and stearyl (meth)acrylate; (meth)acrylate ester derivatives; and conjugated dienes such as butadiene and isoprene. These monomers may be used singly or in combination of two or more species.

The above-mentioned polyfunctional monomer is not particularly limited and it includes, for example, divinylbenzene; and polyfunctional (meth)acrylates such as ethyleneoxide di(meth)acrylate, tetraethyleneoxide di(meth)acrylate, polyethylene glycol di(meth)acrylate, polypropylene glycol di(meth)acrylate, polytetramethylene glycol di(meth)acrylate, 1,6-hexanediol di(meth)acrylate, neopentyl glycol di(meth)acrylate, trimethylolpropane tri(meth)acrylate, tetramethylolmethane tri(meth)acrylate and tetramethylolpropane tetra(meth)acrylate, and these monomers may be used singly or in combination of two or more species.

Among the above-mentioned polyfunctional monomers, when polyfunctional (meth)acrylate is used, it is thought that a glass transition point of the surface of the spherical resin fine particle becomes low as described above. By virtue of the low glass transition point through the existence of this polyfunctional (meth)acrylate, it becomes more hard to move after being sprayed onto a liquid crystal panel when the spherical resin fine particle is used as a spacer for a liquid crystal display device.

Accordingly, the method of producing a spherical resin fine particle of the second present invention is preferably a method by which the polymerizable unsaturated monomer contains polyfunctional (meth)acrylate in an amount 50 to 100% by weight.

An amount of the above-mentioned polymerizable unsaturated monomer to be added is preferably 1 to 200 parts by weight with respect to 1 part by weight of the seed particle since when this amount is small, a crosslinked component is insufficient and the mechanical strength of the polymer particle to be produced becomes insufficient, and when it is large, the accuracy of a particle diameter of the polymer particle to be produced becomes poor.

The above-mentioned polymerization initiator is not particularly limited as long as it can be dispersed in water and for example, an oil-soluble polymerization initiator is suitably used as the polymerization initiator.

Examples of the above-mentioned oil-soluble polymerization initiator include organic peroxides such as benzoyl peroxide, lauroyl peroxide, o-chlorobenzoyl peroxide, o-methoxybenzoyl peroxide, 3,5,5-trimethyl hexanoyl peroxide, tert-butyl peroxy-2-ethyl hexanoate and di-tert-butylperoxide; and azo compounds such as azobisisobutylonitrile, azobis(cyclohexacarbonitrile) and 2,2′-azobis(2,4-dimethylvaleronitrile).

In the production method of the second present invention, it is necessary to obtain a polymer particle by dispersing the above polymerizable unsaturated monomer and the above polymerization initiator in water, then absorbing the polymerizable unsaturated monomer and the polymerization initiator in the seed particle and further polymerizing the polymerizable unsaturated monomer. Specifically, for example, together with the oil-soluble polymerization initiator, the above-mentioned polymerizable unsaturated monomer is finely dispersed in water to form a finely dispersed emulsion. And then the finely dispersed emulsion is mixed with the seed particle dispersed in the aqueous dispersion medium (a seed particle dispersion) whereby the polymerizable unsaturated monomer and the oil-soluble polymerization initiator are adsorbed on and absorbed in the seed particle. Then, the polymerizable unsaturated monomer is polymerized.

In the production method of the second present invention, it is preferred that the polymerizable unsaturated monomer is polymerized with the addition of polyvinyl alcohol having a weight average molecular weight of 10000 to 100000 as a dispersion stabilizer.

The polyvinyl alcohol as a dispersion stabilizer can exists at the surface of a polymer particle, and through the existence of the polyvinyl alcohol having a weight average molecular weight of 10000 to 100000 at the surface of a polymer particle, the polymer particle to be obtained will exhibit an excellent ability to be sprayed onto a liquid crystal panel, for example when it is used as a spacer for a liquid crystal display device. In addition, the existence of polyvinyl alcohol at the surface of a polymer particle means that polyvinyl alcohol exists at the surface of a polymer particle without being cleaned or removed even after cleaning the polymer particle well while heating.

The polyvinyl alcohol used as a dispersion stabilizer acts as a dispersion stabilizer of the seed particle in dispersing the seed particle in an aqueous dispersion medium and further also acts as a dispersion stabilizer of the seed particle swelled after the polymerizable unsaturated monomer and the polymerization initiator are absorbed in the seed particle and swelled. Therefore, polyvinyl alcohol may be added when the seed particle is dispersed in an aqueous dispersion medium (hereinafter, this addition is referred to as an initial addition), or polyvinyl alcohol may be added after the polymerizable unsaturated monomer and the polymerization initiator are absorbed in the seed particle and swelled (hereinafter, this addition is referred to as a late addition). Further, the initial addition and the late addition may be employed in combination.

It is preferred that a weight average molecular weight of the above-mentioned polyvinyl alcohol is 10000 to 100000. When the weight average molecular weight is less than 10000, an effect as a dispersion stabilizer may be decreased, and when the weight average molecular weight is more than 100000, the seed particle may become apt to cohere at the time of initial addition.

An amount of the above-mentioned polyvinyl alcohol to be added is preferably 0.5 to 5000 parts by weight with respect to 100 parts by weight of the seed particle. When this amount is less than 0.5 parts by weight, an effect as a dispersion stabilizer may be decreased, and when it is more than 5000 parts by weight, the seed particle may become apt to cohere at the time of initial addition.

In the production method of the second present invention, a surfactant or a high polymer dispersion stabilizer may be further added in order to improve the dispersion stability.

Examples of the above-mentioned surfactant include anionic surfactants such as sodium lauryl sulfate, triethanolamine lauryl sulfate and laurylbenzenesulfonic acid sodium.

Examples of the above-mentioned high polymer dispersion stabilizer include polyvinylpyrrolidone, gelatin, starch, hydroxyethyl cellulose, and polyvinyl ether.

These may be used singly or in combination of two or more species.

In the production method of the second present invention, for dispersing the polymerizable unsaturated monomer and the polymerization initiator in water, the polymerizable unsaturated monomer and the polymerization initiator may be finely dispersed with a homogenizer, or may be finely dispersed through ultrasonic processing or with a nanomizer or a mount gaulin type fine emulsifier.

Further, for obtaining a finely dispersed emulsion of the above both components, both components might be mixed previously and then finely dispersed. Alternatively, the respective components may be finely dispersed separately and then both components may be mixed.

A particle diameter of the finely dispersed emulsion is preferably smaller than that of the above-mentioned seed particle. By selecting such a particle diameter, it is possible to increase a rate at which the above polymerizable unsaturated monomer and the above polymerization initiator are finely dispersed in water, adsorbed on the seed particle, and diffused. If this rate of diffusion becomes low, the accuracy of particle size distribution of the polymer particle to be produced becomes low.

The adsorption of the above-mentioned finely dispersed emulsion on the above-mentioned seed particle is carried out, for example, by mixing the seed particle dispersion and the finely dispersed emulsion and stirring the resulting mixture at room temperature for 1 to 12 hours, but the adsorption can be accelerated by heating the mixture to 30 to 50° C.

A polymerization temperature in the production method of the second present invention can be appropriately selected in accordance with the species of the polymerizable unsaturated monomer or the polymerization initiator to be used, but generally, it is preferably 25 to 100° C., and more preferably 60 to 90° C.

Further, it is preferred to initiate polymerization after the above-mentioned polymerizable unsaturated monomer and polymerization initiator are entirely adsorbed on and absorbed in the seed particle.

The polymerized polymer particle can be generally separated from a medium by centrifugation. The separated polymer particle can be purified by cleaning repeatedly with alcohol or water. It is possible to isolate the polymer particle through spray drying or vacuum drying after cleaning.

A spacer for a liquid crystal display device, which consists of a particle obtained using the spherical resin fine particle of the first present invention or a spherical resin fine particle produced by the method of producing a spherical resin fine particle of the second present invention, also constitutes the present invention.

The spacer for a liquid crystal display device of the third present invention consists of a particle obtained using the spherical resin fine particle of the first present invention or a spherical resin fine particle produced by the method of producing a spherical resin fine particle of the second present invention.

Since the spacer for a liquid crystal display device of the third present invention consists of a particle obtained using a spherical resin fine particle having a smooth surface, it is possible to obtain a spacer for a liquid crystal display device, which has a smooth surface and hardly moves after being sprayed onto a liquid crystal panel.

Further, when the spacer for a liquid crystal display device of the third present invention is a crosslinked resin including a polymer in an amount 90% by weight or more, which consists of a polymerizable unsaturated monomer containing polyfunctional (meth)acrylate in an amount 50 to 100% by weight, it becomes more hard to move after being sprayed onto a liquid crystal panel. In addition, since the spacer for a liquid crystal display device of the third present invention is a crosslinked resin, it becomes a substance having appropriate mechanical strength.

The above-mentioned spacer for a liquid crystal display device is used for maintaining a thickness of a liquid crystal layer uniform and constant in a liquid crystal display device.

When the spherical resin fine particle in the present invention is used as a spacer for a liquid crystal display device, it may be treated with carbon black, a disperse dye, an acid dye, a basic dye, or metal oxide to be colored in order to improve the contrast of the liquid crystal display device.

Further, the above-mentioned spacer for a liquid crystal display device can be utilized as a functional spacer by providing a new surface layer on its surface. By forming, for example, an adhesive layer on its surface, it is possible to provide an anti-movement spacer which is adherent to a substrate, and by providing a layer with small surface energy, it is also possible to provide an anti-abnormal alignment spacer in which a force of alignment regulation on a liquid crystal is reduced. These surface layers can be formed by coating methods such as a coacervation process, an interfacial polymerization process and a mechanochemical process.

Since the present invention has the above-mentioned constitution, it becomes possible to attain a spherical resin fine particle which has a smooth surface even though it is formed by seed polymerization, a method of producing the spherical resin fine particle, and a spacer for a liquid crystal display device using the spherical resin fine particle, which has a smooth surface and hardly moves after being sprayed onto a liquid crystal panel.

Further, when the spacer for a liquid crystal display device of the present invention is a crosslinked resin including a polymer in an amount 90% by weight or more, which consists of a polymerizable unsaturated monomer containing polyfunctional (meth)acrylate in an amount 50 to 100% by weight, it becomes more hard to move after being sprayed onto a liquid crystal panel, and it becomes a substance having appropriate mechanical strength since it is a crosslinked resin.

Hereinafter, the present invention will be described in more detail by way of examples, but the present invention is not limited to the following examples.

### Preparation of Seed Particle

(Seed Particle A)

In a separable flask, 18 parts by weight of polyvinylpyrrolidone, 5 parts by weight of an anionic surfactant “Aerosol OT”, 8 parts by weight of azobisisobutylonitrile, 100 parts by weight of styrene, 5 parts by weight of a chain transfer agent, and 864 parts by weight of methanol were put, and the resulting mixture was dissolved while being stirred. Then, the mixture was polymerized by heat at 60° C. while continuing stirring to obtain a dispersion of a seed particle.

The obtained dispersion was cleaned with methanol and centrifuged and then it was further subjected to cleaning and displacing the obtained dispersion in water and freeze-dried to obtain a polystyrene seed particle A.

A molecular weight was measured by GPC (gel permeation chromatography) on the obtained polystyrene seed particle A. Consequently, a weight average molecular weight was 6000 and (weight average molecular weight)/(number average molecular weight) was 1.5. Further, a number average particle diameter of the seed particle A, measured with a MICROTRAC particle size analyzer “Model 9320-X100” manufactured by NIKKISO CO., LTD., was 1.1 μm.

(Seed Particle B)

A polystyrene seed particle B was obtained by following the same procedure as in the seed particle A except for using 1.6 parts by weight of azobisisobutylonitrile in place of 8 parts by weight of azobisisobutylonitrile.

A molecular weight was measured by GPC on the obtained polystyrene seed particle B. Consequently, a weight average molecular weight was 26000 and (weight average molecular weight)/(number average molecular weight) was 2.4. Further, a number average particle diameter measured in the same manner as in the seed particle A was 1.1 μm.

### EXAMPLE 1

0.7 parts by weight of the obtained polystyrene seed particle A was put in a separable flask, and to this, 1.4 parts by weight of an aqueous solution of triethanolamine lauryl sulfate and 23.8 parts by weight of a 5% by weight aqueous solution of polyvinyl alcohol (saponification degree 87.8 mol %, weight average molecular weight 15000) for an initial addition were added. The resulting mixture was subjected to ultrasonic processing for 30 minutes to prepare a seed particle dispersion.

Onto the obtained seed particle dispersion, emulsion, which was obtained by adding 42.9 parts by weight of divinylbenzene, 2.4 parts by weight of benzoyl peroxide, 21.4 parts by weight of ethanol and 1.9 parts by weight of an aqueous solution of triethanolamine lauryl sulfate to 235.6 parts by weight of ion-exchange water and finely dispersing the resulting mixture with a static dispersing apparatus, was added dropwise while stirring.

After divinylbenzene was absorbed in the seed particle and the seed particle completed swelling, 128.1 parts by weight of a 5.5% by weight aqueous solution of polyvinyl alcohol (saponification degree 87.8 mol %, weight average molecular weight 100000) for a late addition was added and the resulting mixture was polymerized by heat at 90° C. for 10 hours while continuing stirring to obtain a dispersion of a polymer particle.

The obtained dispersion was cleaned with hot water and centrifuged, and then it was further cleaned, filtrated and vacuum-dried to obtain a spherical resin fine particle.

A number average particle diameter, a CV value, surface conditions, and adherence were evaluated by the following methods on the obtained spherical resin fine particle. The results of the evaluations are shown in Table 1.

### Number Average Particle Diameter, CV Value

The number average particle diameter and the CV value of the spherical resin fine particle were determined by “Multisizer 3” manufactured by Beckman Coulter K. K.

### Surface Conditions

10 spherical resin fine particles were observed using a plane of orthographic projection by a FE-SEM type electron microscope (“S-4500” manufactured Hitachi, Ltd.).

This observation was carried out under the conditions of an acceleration voltage: 5 kV, a working distance: 10 mm, an emission current: 10 μA and an f number: 4.

Further, a magnification of the microscope was set at 20000 times for at least 1 μm and less than 4 μm, 15000 times for at least 4 μm and less than 7 μm, 10000 times at least 7 μm and less than 10 μm, and 5000 times for at least 10 μm and less than 15 μm.

With respect to 10 spherical resin fine particles, each of projection sections presented in a circle, which has a diameter of half of that of the spherical resin fine particle and is concentric with the spherical resin fine particle, was marked off and the number of the marked off areas was counted and averaged.

### Adherence

The obtained spherical resin fine particle was used as a spacer for a liquid crystal display device and the spacers were sprayed onto a liquid crystal panel by a sprayer manufactured by Nisshin Engineering Inc. and air was blown on the liquid crystal panel subjected to spraying for 5 seconds at an air pressure of 49 kPa or 98 kPa from the point at 30 mm distance in a slanting direction of 45° angle and number of particles before and after air blowing was counted. A ratio of number of particles remaining after air blowing to number of particles existing on the liquid crystal panel before air blowing was determined on a percentage basis and this percentage was assumed to be an adherence ratio of a spacer.

### EXAMPLE 2

A spherical resin fine particle was obtained by following the same procedure as in Example 1 except for using 42.9 parts by weight of polytetramethylene glycol diacrylate in place of 42.9 parts by weight of divinylbenzene of Example 1.

A number average particle diameter, a CV value, surface conditions, and adherence were evaluated in the same manner as in Example 1 on the obtained spherical resin fine particle. The results of the evaluations are shown in Table 1.

### COMPARATIVE EXAMPLE 1

1.7 parts by weight of the obtained polystyrene seed particle A was put in a separable flask, and to this, 3.3 parts by weight of an aqueous solution of triethanolamine lauryl sulfate and 57.7 parts by weight of a 5% by weight aqueous solution of polyvinyl alcohol (saponification degree 87.8 mol %, weight average molecular weight 15000) for an initial addition were added. The resulting mixture was subjected to ultrasonic processing for 30 minutes to prepare a seed particle dispersion.

Onto the obtained seed particle dispersion, emulsion, which was obtained by adding 11.7 parts by weight of divinylbenzene, 0.7 parts by weight of benzoyl peroxide, 5.8 parts by weight of ethanol and 0.5 parts by weight of an aqueous solution of triethanolamine lauryl sulfate to 64.1 parts by weight of ion-exchange water and finely dispersing the resulting mixture with a static dispersing apparatus, was added dropwise while stirring.

After divinylbenzene was absorbed in the seed particle and the seed particle completed swelling, 123.9 parts by weight of a 5.5% by weight aqueous solution of polyvinyl alcohol (saponification degree 87.8 mol %, weight average molecular weight 100000) for a late addition was added and the resulting mixture was polymerized by heat at 90° C. for 10 hours while continuing stirring to obtain a dispersion of a polymer particle.

The obtained dispersion was cleaned with hot water and centrifuged, and then it was further cleaned, filtrated and vacuum-dried to obtain a spherical resin fine particle.

A number average particle diameter, a CV value, surface conditions, and adherence were evaluated in the same manner as in Example 1 on the obtained spherical resin fine particle. The results of the evaluations are shown in Table 1.

### COMPARATIVE EXAMPLE 2

A spherical resin fine particle was obtained by following the same procedure as in Example 1 except for using 0.7 parts by weight of the polystyrene seed particle B in place of 0.7 parts by weight of the polystyrene seed particle A of Example 1.

A number average particle diameter, a CV value, surface conditions, and adherence were evaluated in the same manner as in Example 1 on the obtained spherical resin fine particle. The results of the evaluations are shown in Table 1.

### COMPARATIVE EXAMPLE 3

A spherical resin fine particle was obtained by following the same procedure as in Comparative Example 1 except for using 1.7 parts by weight of the polystyrene seed particle B in place of 1.7 parts by weight of the polystyrene seed particle A of Comparative Example 1.

A number average particle diameter, a CV value, surface conditions, and adherence were evaluated in the same manner as in Example 1 on the obtained spherical resin fine particle. The results of the evaluations are shown in Table 1.

TABLE 1

| | | | | Comp. | Comp. | Comp. |
|---|---|---|---|---|---|---|
| | | Ex. 1 | Ex. 2 | Ex. 1 | Ex. 2 | Ex. 3 |
| Seed | Weight Average Molecular Weight | 6000 | 6000 | 6000 | 26000 | 26000 |
| Particle | (Weight Average Molecular Weight)/ | 1.5 | 1.5 | 1.5 | 2.4 | 2.4 |
| | (Number Average Molecular Weight) | | | | | |
| Spherical | Swelling Degree | 61-fold | 61-fold | 7-fold | 61-fold | 7-fold |
| Resin | Number Average Particle Diameter | 4.7 μm | 4.7 μm | 2.3 μm | 4.6 μm | 2.2 μm |
| Fine | CV Value | 2.5% | 2.6% | 2.6% | 2.7% | 3.2% |
| Particle | Number of Areas Including a | 0 | 0 | 30 | 20 | 35 |
| | Projection Section | | | | | |
| | Adherence Ratio (49 kPa) | 98% | 99% | 52% | 17% | 29% |
| | Adherence Ratio (98 kPa) | 70% | 98% | 17% | 0% | 8% |

From Table 1, it is apparent that in Examples, number of the marked off areas is 10 or less and the spherical resin fine particle has a smooth surface.

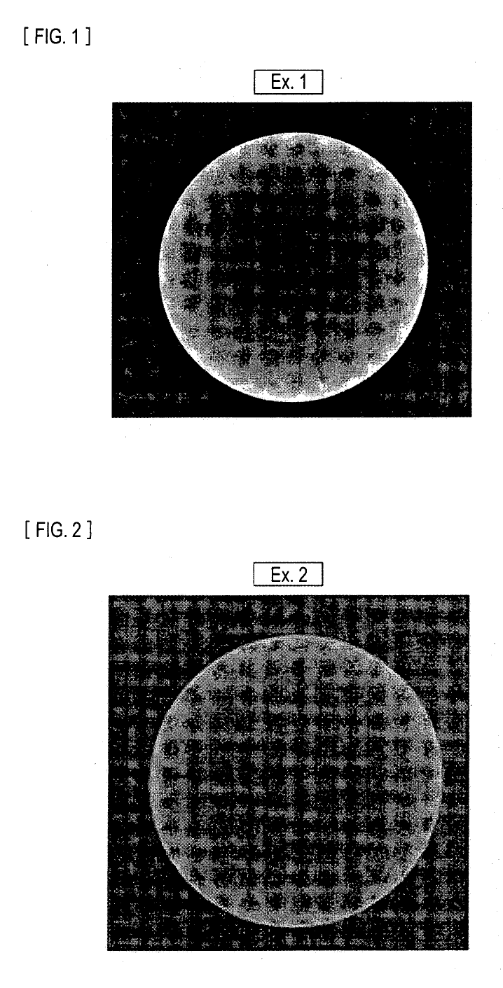

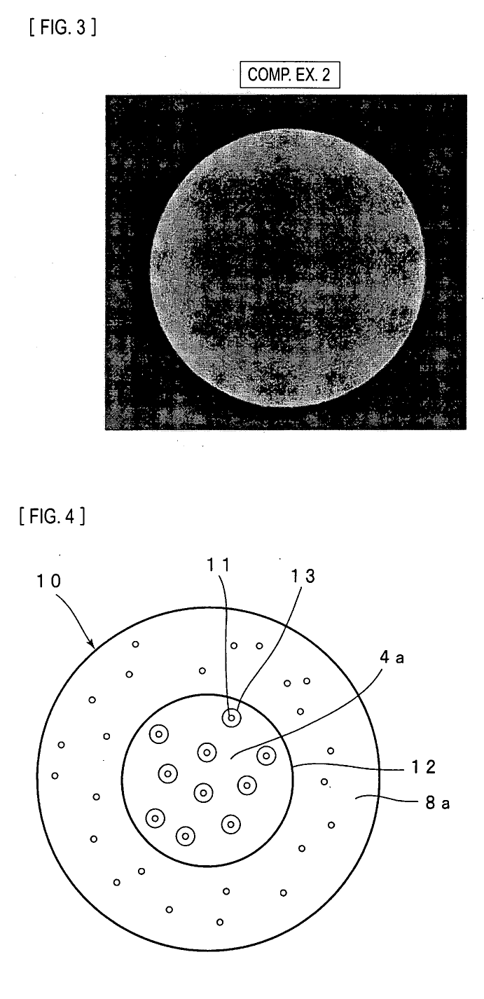

FE-SEM type electron microscope photographs of the spherical resin fine particles obtained in Examples 1 and 2 and Comparative Example 2 are shown in FIGS. 1, 2 and 3, respectively.

Further, since the spherical resin fine particles have a smooth surface in Examples, they are high in adherence ratio, and since the spherical resin fine particle of Example 2 is a spherical resin fine particle using polyfunctional acrylate in a specific amount, it is further high in adherence ratio.

In accordance with the present invention, it is possible to provide a spherical resin fine particle which has a smooth surface even though it is formed by seed polymerization process, a method of producing the spherical resin fine particle, and a spacer for a liquid crystal display device using the spherical resin fine particle, which has a smooth surface and hardly moves after being sprayed onto a liquid crystal panel.

1. A spherical resin fine particle obtained by seed polymerization, wherein when the surface of said spherical resin fine particle is observed with a FE-SEM type electron microscope and a projection section presented at the surface of the spherical resin is marked off as an area in a plane of orthographic projection of the spherical resin fine particle, number of said areas presented in a circle, which has a diameter of half of that of the spherical resin fine particle and is concentric with the spherical resin fine particle, is 10 or less.

2. The spherical resin fine particle according to claim 1, wherein said spherical resin fine particle has a number average particle diameter of 1 to 10 μm.

3. The spherical resin fine particle according to claim 1, wherein said spherical resin fine particle is a crosslinked resin including a polymer, consisting of a polymerizable unsaturated monomer containing polyfunctional (meth)acrylate in an amount 50 to 100% by weight, in an amount 90% by weight or more.

4. A method of producing the spherical resin fine particle according to claim 1, wherein a polymerizable unsaturated monomer and a polymerization initiator are dispersed in water and then absorbed in the seed particle, which has a weight average molecular weight of 2000 to 15000 and in which (weight average molecular weight)/(number average molecular weight) is 1.6 or less, in a swelling degree of 10-fold to 100-fold and the absorbed polymerizable unsaturated monomer is polymerized to obtain a polymer particle.

5. The method of producing a spherical resin fine particle according to claim 4, wherein the polymerizable unsaturated monomer contains polyfunctional (meth)acrylate in an amount 50 to 100% by weight.

6. A spacer for a liquid crystal display device, wherein said spacer consists of a particle obtained using the spherical resin fine particle according to claim 1.

7. The spherical resin fine particle according to claim 2, wherein said spherical resin fine particle is a crosslinked resin including a polymer, consisting of a polymerizable unsaturated monomer containing polyfunctional (meth)acrylate in an amount 50 to 100% by weight, in an amount 90% by weight or more.

8. A method of producing the spherical resin fine particle according to claim 2, wherein a polymerizable unsaturated monomer and a polymerization initiator are dispersed in water and then absorbed in the seed particle, which has a weight average molecular weight of 2000 to 15000 and in which (weight average molecular weight)/(number average molecular weight) is 1.6 or less, in a swelling degree of 10-fold to 100-fold and the absorbed polymerizable unsaturated monomer is polymerized to obtain a polymer particle.

9. The method of producing a spherical resin fine particle according to claim 8, wherein the polymerizable unsaturated monomer contains polyfunctional (meth)acrylate in an amount 50 to 100% by weight.

10. A spacer for a liquid crystal display device, wherein said spacer consists of a particle obtained using the spherical resin fine particle according to claim 2.

11. A spacer for a liquid crystal display device, wherein said spacer consists of a particle obtained using the spherical resin fine particle according to claim 3.

12. A spacer for a liquid crystal display device, wherein said spacer consists of a particle obtained using the spherical resin fine particle according to claim 7.

13. A spacer for a liquid crystal display device, wherein said spacer consists of a particle obtained using a spherical resin fine particle produced by the method according to claim 4.

14. A spacer for a liquid crystal display device, wherein said spacer consists of a particle obtained using a spherical resin fine particle produced by the method according to claim 5.

15. A spacer for a liquid crystal display device, wherein said spacer consists of a particle obtained using a spherical resin fine particle produced by the method according to claim 8.

16. A spacer for a liquid crystal display device, wherein said spacer consists of a particle obtained using a spherical resin fine particle produced by the method according to claim 9.
